(19) United States
(12) Patent Application Publication
(10) Pub. No.: US 2007/0084903 A1
(43) Pub. Date: Apr. 19, 2007

(54) Pronged fork probe tip

(76) Inventor: Alexander Leon, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/250,031

(22) Filed: Oct. 13, 2005

(51) Int. Cl. B23K 1/005

(52) U.S. Cl. 228/51

(57) ABSTRACT

Provided is a pronged fork probe tip for probing a node, such as a through-hole node, on a circuit. The probe tip has a shaft made from an electrically conductive material, concentric to a longitudinal probe axis, and two fork prongs coupled to the shaft and positioned parallel to the probe axis. The two fork prongs provide two geometrically singular points of contact, concentrating applied force from the shaft to the node hole, and more particularly, to solder within the node hole, at two points. A self-cleaning space between the fork prongs aids in preventing clogging of the probe by flux material and/or debris. The shaft may also include a plunger and/or a structure to provide a preferred fixed orientation by preventing rotation of the probe about the probe axis.

### FIELD

This invention relates generally to the field of electrical test probes and, in particular, to a pronged fork probe.

### BACKGROUND

Typically, modern electrical products incorporate printed circuit assemblies (PCAs), such as printed circuit boards (PCBs). The range of products is immense, including cell phones, laptops televisions, MP3 players, game consoles, personal data assistant and aircraft components, to name just a few.

The printed circuits within these products interconnect a variety of circuit components, such as diodes, transistors, resistors, integrated circuits and the like. Fabricated as individual components, each generally has one or more legs or pins (commonly referred to as leads). The individual components are brought into useful harmony by a circuit board that provides electrical traces to and from different components as well as areas that facilitate the permanent mounting of components upon the board.

Due to fabrication complexity of many products, the PCAs are assembled in stages. A given PCA and at least some of the components thereon may therefore be subjected to repeated processing steps. As such, the components frequently require monitoring and testing during the fabrication process to insure that the ultimate device is functional. If an uncorrectable defect is detected early, additional fabrication costs may be saved by halting further assembly of the defective product.

Electrical test probes are used to provide electrical connections between PCA components and testing instruments. An electrical test probe generally consists of an electrically conductive probing tip joined to an electrically conductive shaft that is in turn connected to a test fixture, which attempts to align the probe to a specific component.

Generally speaking, the components are attached to the PCA by solder. Environmental and regulatory factors have effected a change in the solder process from lead based solder to lead free solder. The use of lead free solder imposes additional fabrication issues upon the assembly and testing process. For through-hole-technology (THT) components, the process and costs of wave soldering can be eliminated by assembling these to the board using through-hole reflow (THR). THR is a way to mount THT components simultaneously with the surface-mount-technology (SMT) components. Typically, the solder is applied in a paste form with the use of a stencil to the circuit board. Components are then pressed into the solder paste, and/or into holes in the board along with solder paste. The board is then heated to the solder melt temperature to reflow the solder such that it wets a pad surface and/or flows about the pins of a component to be joined to the board. In addition to the solder metal, the solder paste also contains a combination of chemicals called flux, which help keep the solder in a paste form, act as adhesive so the paste sticks to the pads and pins, thereby holding the components on the board before being reflowed, and clean the metal of pads and pins in order to achieve a good solder joint. The reflowing process releases the flux components of the paste and leaves flux residue on the board and solder joints. The flux residue is a combination of non-conductive materials.

Holes in the board are frequently used to mount components and/or provide board interconnections. When the reflowed solder flows into these holes it may partially or completely fill them. Flux material also will flow into the hole and gather on top of the reflowed solder. The flux material may lie below the pad of the hole, be flush with it or flood or protrude over it.

When the hole and/or its surrounding pad are the target of a test probe, the flux residue may prevent a reliable and repeatable electrical connection between the pad and the target when urged with each other. Also, a certain amount of force is generally used when the test probe tip is urged into the solder. If too much force is applied, this may break solder joints, components or the board itself. If too little force is applied the probe may not make sufficient contact with the solder and a valid component may be judged to be defective. Thus, a low force that repeatably makes good electrical contact between a test probe and its target is desirable.

Most conventional test probe tips are generally in the shape of a cone or other shape that narrows to a point. Such a point in line with the probe's longitudinal axis permits a concentration of force in line with that axis, and thus also limits probe wear. With respect to a through hole filled with solder having concave meniscuses in turn filled by flux residue pooled therein, the conventional probes' point targets the deepest portion of the flux pool. Attempts to contact the solder may thus be frustrated, and testing may fail despite the node actually being properly functional.

Probe tips in the shapes of cups, crowns and radial stars with three or more tips for alignment over mounded solder elements also exist. However, as the number of contact points increases, so too does the surface area of contact. More specifically, as the points of contact increase, the concentration of applied force transferred to each point decreases.

This can be illustrated by the example of a man on snow shoes. The man may walk across a soft snow because the snow shoes distribute his weight upon the snow across a large surface area. In a more specific example, a force magnitude of 12 units (arbitrary) applied by a single point to a surface will transfer a force magnitude of 12. The same force applied by three points sees each point apply a force magnitude of only 4—a third of the total force (12÷3=4). In other words, the contact force applied by the plunger is divided by the number of contact points, resulting in a lower contact force per tip. Materials limit how small the contact surface area of each tip can be made. Thus the pressure applied by a single tip probe will be three times higher than that applied by each tip of a three tip probe—assuming all tips have equivalent contact surface areas.

Thus, the multiplicity of points of contact from start tips, crown tips or the like may further frustrate the attempt to achieve a proper electrical contact between the probe tip and the solder. Single flat blade probe tips are likewise also frustrated by the presence of flux, as they provide a large surface area for contact and thus result in lower contact pressure (force over contact area).

In addition, cupped tips and multi point tips may easily be fowled by flux material. As the probe tip attempts to reach the solder below the flux material, the flux material is compacted into the cup and/or between and about the multiple tips. Such material may collect to such a point where the probe tips are simply unable to make electrical contact, with even clean test locations.

In short, single point tips are not well suited for probing through holes clogged or capped by flux material as the single point tip tends to be aligned for center of the hole where the flux material is most thick. Flat blade probe tips and tips with three or more tips result in force distribution over an increased surface area. Multi-point tips, which may avoid the thick portions of flux material, have less force to penetrate through the flux residue and are easily fouled by flux collecting at the probe tip, and are therefore unable to make repeatable and reliable electrical contact.

Consequently, the necessary electrical contact between the probe and the solder is not achieved in all situations and the testing system may wrongly evaluate a healthy board and/or component as defective, due simply to the contact failure. Also, bad contact may lead to incorrectly passing a bad board. Such incorrect evaluations are costly, either due to costly troubleshooting involved, good product becoming scrapped or profitability being impacted by bad product becoming deployed and in turn necessitating costly customer support under warranty.

Hence, there is a need for a device that overcomes one or more of the drawbacks identified above.

### SUMMARY

This invention provides a contact probe tip for probing a node on a circuit.

In particular, and by way of example only, according to an embodiment, provided is a pronged fork probe tip for probing a node on a circuit, including: a longitudinal probe axis; a shaft made from an electrically conductive material, the shaft concentric to the probe axis; two fork prongs coupled to the shaft and parallel to the probe axis, each fork prong providing an end contact point; and a self-cleaning space disposed between the two fork prongs.

### BRIEF DESCRIPTION OF THE DRAWINGS

FIG. 1 shows a face view of a two pronged fork probe according to an embodiment;

FIG. 2 shows a side view cross-section of the pronged fork probe in FIG. 1;

FIG. 3 shows a partial perspective view of a pronged fork probe according to an embodiment;

FIG. 4 shows a side view cross-section of a pronged fork probe showing a self-cleaning space deflecting debris, according to an embodiment;

FIG. 5 shows a side view cross-section of an alternative embodiment configuration for the pronged fork probe shown in FIG. 1;

FIG. 6 is a partial perspective view of an alternative pronged fork probe;

FIG. 7 is a face view of the pronged fork probe shown in FIG. 6;

FIG. 8 shows a side view cross-section the pronged fork probe shown in FIG. 7;

FIG. 9 shows two alternative head and shaft configurations for pronged fork probes according to alternative embodiments;

FIG. 10 is a side view of an embodiment of a pronged fork probe;

FIG. 11 is a side view of an alternative embodiment of a pronged fork probe;

FIG. 12 is a side view of an alternative embodiment of a pronged fork probe;

FIG. 13 is a side view of an alternative embodiment of a pronged fork probe;

FIG. 14 is a fork prong end view of the pronged fork probe shown in FIG. 9;

FIG. 15 is a face view of a headed embodiment of a pronged fork probe;

FIG. 16 is a face view of a headless alternative embodiment of a pronged fork probe;

FIG. 17 is a face view of a tapered alternative embodiment of a pronged fork probe;

FIG. 18 is a partial perspective view of a pronged fork probe including a plunger according to an alternative embodiment;

FIG. 19 shows a method of use for a pronged fork probe according to an embodiment;

FIG. 20 shows a top view of a node hole tested with a pronged fork probe; and

FIG. 21 is a high level flow diagram of the method of use.

### DETAILED DESCRIPTION

Before proceeding with the detailed description, it is to be appreciated that the present teaching is by way of example, not by limitation. The concepts herein are not limited to use or application with a specific two pronged fork probe. Thus, although the instrumentalities described herein are for the convenience of explanation, shown and described with respect to exemplary embodiments, it will be appreciated that the principles herein may be equally applied in other types of pronged fork probes.

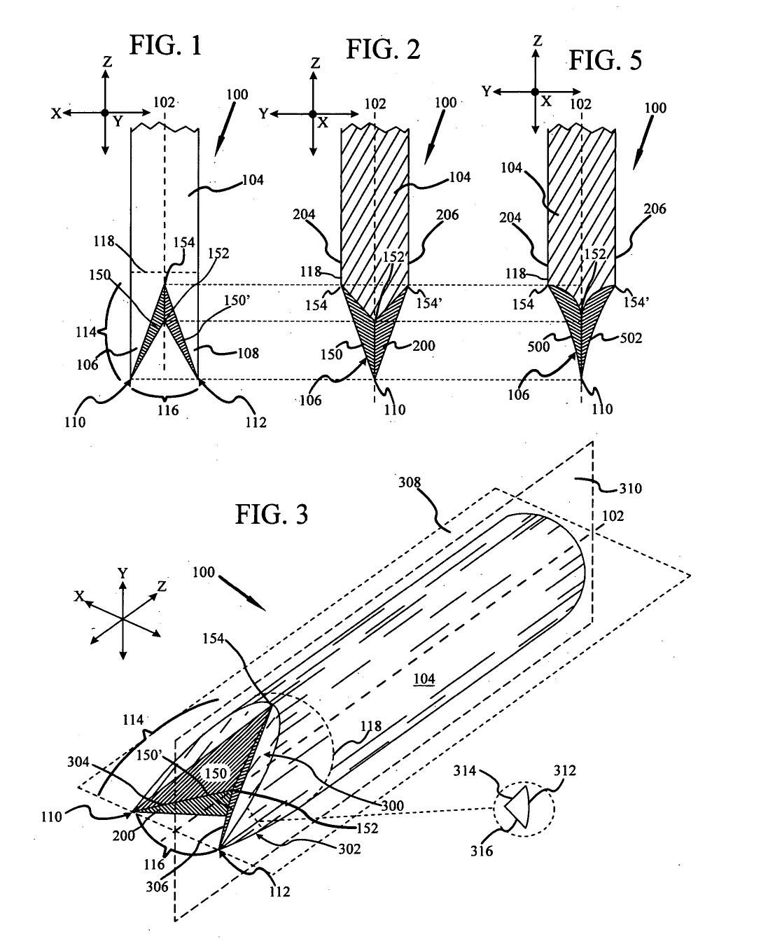

Referring now to the drawings, and more specifically FIGS. 1˜4, there is shown a pronged fork probe tip 100 for probing a node on a circuit, specifically, in at least one embodiment, a hole node. In at least one embodiment, the pronged fork probe tip 100 has a longitudinal probe axis 102, a shaft 104 concentric to the probe axis 102, and two fork prongs 106, 108, each providing an end contact point 110, 112, the fork prongs 106, 108 and contact points 110, 112 providing a probe tip 114.

The two fork prongs 106, 108 are coupled to the shaft 104 and positioned about the probe axis 102, and provide apices of tip 114. Each fork prong 106, 108 is parallel to the probe axis 102. In at least one embodiment, the fork prongs 106, 108 are coupled to the shaft 104 on opposing sides of the probe axis 102. Moreover, in at least one embodiment the fork prongs 106, 108 lie in the same plane 308 (see FIG. 3), the plane parallel to and including the probe axis 102. Such a configuration may provide a two pronged fork probe tip 100 that is symmetric about probe axis 102. In at least one alternative embodiment, the fork prongs 106, 108 do not lie in the same plane as the probe axis 104, and as such pronged fork probe tip 100 is not symmetric about probe axis 102. The contact points 110, 112 lie in a plane that is transverse to the probe axis 104.

The structure of pronged fork probe tip 100 may be further appreciated with respect to the partial perspective provided in FIG. 3. Moreover, in at least one embodiment, the tip 114 is defined by two opposing faces 300, 302 about the probe axis 102. The faces 300, 302 converge towards each other along a first axis (shown as the Z axis) substantially parallel to probe axis 102. The faces 300, 302 separate and taper to contact points 110, 112 along a second axis (shown as the X axis) transverse to the probe axis 102. Moreover, the tapering and separating of the faces 300, 302 provide fork prongs 106, 108 on opposing sides of probe axis 102. Each fork prong 106, 108 in turn respectively provides contact points 110, 112.

Fork prongs 106, 108 further define an area or space 116 between the contact points 110, 112. This space 116 divides the apex of tip 114 as provided by the fork prongs 106, 108 and imposed upon the probe axis 102. As is further discussed below, space 116 is a self-cleaning space.

It is to be understood and appreciated that fork prongs 106, 108 provide pinpoint contact points 110, 112; In other words contact points 110, 112 are sharp tips providing substantially singular points of contact, as distinguished from multi-point geometric surfaces or areas of contact in a common plane.

FIG. 2 provides a cross sectional view of the pronged fork probe tip 100 shown in FIG. 1 along probe axis 102, showing one half of the self-cleaning space 116. As shown, the illustrated portion of self-cleaning space 116 is formed by a first surface 150 extending from contact point 110 to side 204 and a second surface 200 extending from contact point 110 to side 206.

With respect to FIGS. 1˜3, self-cleaning space 116 has a central area vertex 152 disposed between the fork prongs 106, 108 in a first plane 308 (XZ plane, see FIG. 3) along the probe axis 102. The self-cleaning space 116 further has exit vertex areas 154 and 154′ above the central area 152. The exit areas 154 and 154′ are in a second plane 310 (YZ plane, see FIG. 3) along a second axis (shown as the Y axis). With respect to FIG. 3, it can be appreciated that the exit area 154 is above the central area vertex 152 with respect to the Z axis as well as the Y axis. Specifically, there is a slope angle from the central area vertex 152 out to the exit area 154 and another to the exit area 154′.

As shown in FIG. 3, first surface 150 as shown is defined by boundaries between contact point 110, central area vertex 152 and exit area vertex 154. First surface 150′ as shown is defined by boundaries between contact point 112, central area vertex 152 and exit area vertex 154. Second surface 200 is defined by boundaries between contact point 110, central area vertex 152 and exit area vertex 154′ (see FIG. 2). A second surface 200′ (not viewable in FIG. 3; see FIG. 14) is defined by boundaries between contact point 112, central area vertex 152 and exit area vertex 154′ (see FIG. 2).

Collectively, the first and second surfaces 150, 150′, 200, 200′ provide the self-cleaning aspect to self-cleaning space 116. As pronged fork probe tip 100 is brought into contact with a node for testing, debris such as solder residue, flux, dirt or other materials may enter self-cleaning space 116. The sloping angles of the first and second surfaces 150, 150′, 200, 200′ advantageously insure that such debris will be deflected away from the axis of the probe and will not lodge in self-cleaning space 116.

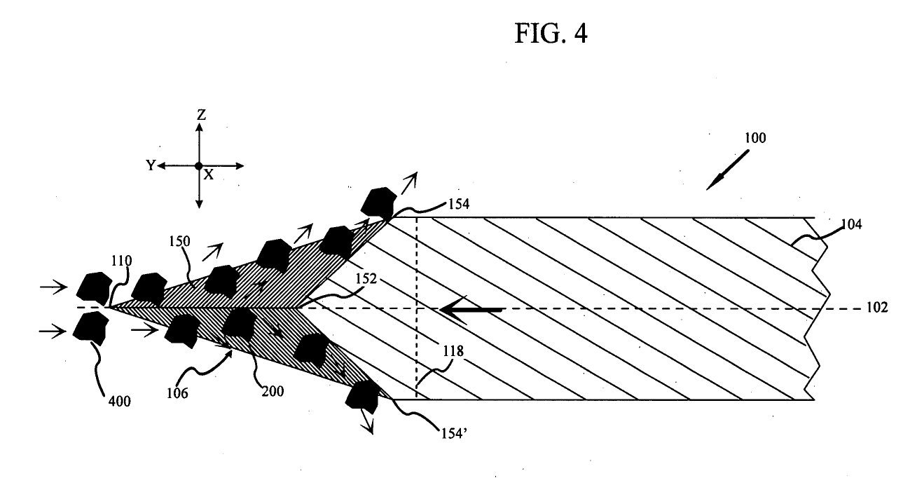

More specifically, first surface 150 and second surface 200 share common edge 304 between contact point 110 and central area vertex 152. Likewise, first surface 150′ and second surface 200′ share common edge 306 between contact point 112 and central area vertex 152. As shown in FIG. 4, any material 400 approaching from the apex of tip 114 and striking either first surface 150 or second surface 200 is deflected away from probe axis 102 and thus away from pronged fork probe tip 100.

As no cavity, bore or other semi-enclosed structure is provided within self-cleaning space 116, self-cleaning space 116 is incapable of trapping and collecting debris materials. Should any debris materials collect upon first or second surfaces 150, 150′, 200, 200′, new debris materials entering self-cleaning space 116 in subsequent probing cycles push the collected material along the first and second surfaces 150, 150′, 200, 200′ away from the probe axis 102 and, as such, prevent the fouling of tip 114.

FIG. 5 provides an alternative side view cross section of the pronged fork probe tip 100 shown in FIG. 1 along probe axis 102. Whereas in FIG. 2 the portion of self-cleaning space 116 is shown with generally flat first and second surfaces 150, 200, in FIG. 5, the first and second surfaces 500, 502 are shown as being curvilinear. Such a curvilinear surface may be advantageous in at least one embodiment to further enhance the self-cleaning aspect of self-cleaning space 116 and as an alternate to facilitate manufacturing.

With respect to FIGS. 1˜3, it is apparent that in at least one embodiment, tip 114 is formed from shaft 104. More specifically, as shaft 104 has a substantially round cross section, it is appreciated that the cross section of each fork prong 106, 108 proximate to each contact point 110, 112, may generally be triangular, having convex side 312 and two flat sides 314, 316.

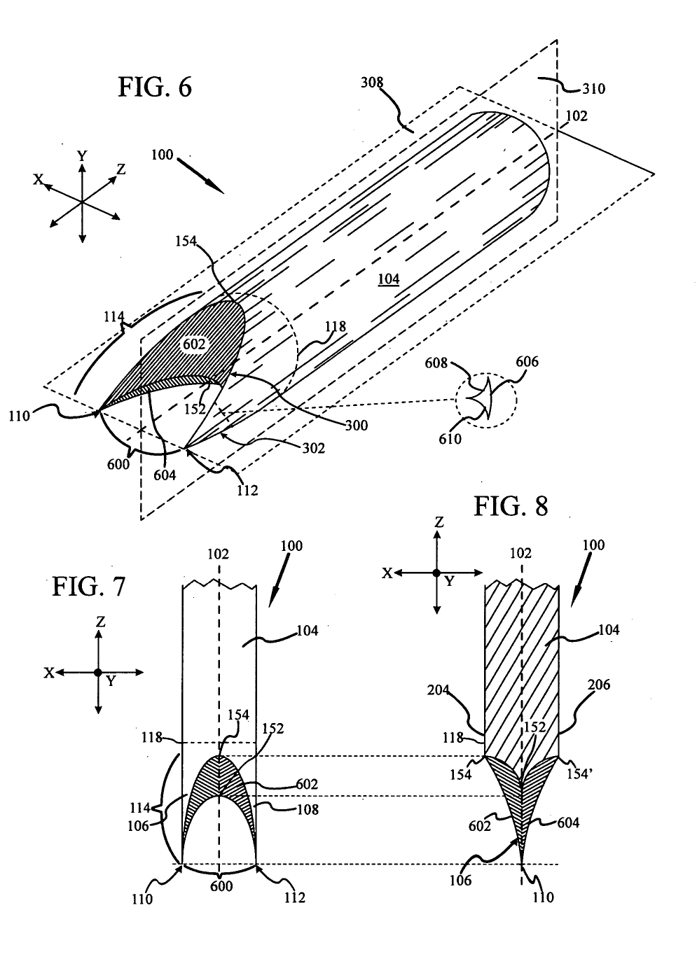

FIGS. 6˜8 provide an alternative embodiment for pronged fork probe tip 100. FIG. 6 presents a partial perspective view of pronged fork probe tip 100. FIG. 7 presents a face view of the pronged fork probe tip 100 shown in FIG. 6, and FIG. 8 presents a side view cross section of the pronged fork probe tip 100 shown in FIG. 6, along the probe axis 102.

As in FIGS. 1˜5, the pronged fork probe tip 100 shown in FIGS. 6˜8 has a longitudinal probe axis 102, a shaft 104 concentric to the probe axis 102, and two separate fork prongs 106, 108 providing a probe tip 114. The two fork prongs 106, 108 provide contact points 110 and 112, respectively.

In contrast to the embodiment illustrated in FIGS. 1˜5, shown in FIGS. 6˜8 is an embodiment wherein the self-cleaning space 600 is provided by two intersecting portions of at least two curved structures. More specifically, the self-cleaning space 600 shown in FIGS. 6˜8 is formed by two curved surfaces 602, 604, each of which may be a portion of a cylinder, sphere, egg-shaped or other three-dimensionally curved surface. As shown, the curved surfaces 602, 604 intersect in first plane 308 (XZ plane) and taper from the central vertex area 152 to contact points 110 and 112.

Substantially as described above with respect to FIG. 4, debris materials entering into the self-cleaning space 600 along a path approximating the probe axis 102 will encounter either curved surface 602 or 604 (in FIG. 4 shown as surfaces 150, 200). As the curved slope of curved surfaces 602, 604 leads away from probe axis 102, the striking debris is deflected away from probe tip 114. As no cavity, bore or other open structure is provided within self-cleaning space 600, self-cleaning space 600 is incapable of trapping and collecting flux residue debris or other materials.

With respect to the self-cleaning spaces 116 and 600, both are shown as symmetric with respect to the probe axis 102. This symmetry is a matter of design preference and may be advantageous for certain embodiments. In alternative embodiments, the self-cleaning space 116 or 600 may be askew from the center axis 102 and/or the center of tip 114. In further addition, self-cleaning spaces 116 and 600 are shown as simple sloped structures. In at least one alternative embodiment the surfaces defining the self-cleaning space (e.g. 150, 150′, 200, 200′, 500, 502, 602, 604) may contour so as to define a corkscrew-like channel or other deflecting passageway (not shown).

With respect to FIGS. 6˜8, it is apparent that in at least one embodiment, tip 114 is formed from shaft 104. More specifically, as shaft 104 has a substantially round cross section, it is appreciated that the cross section of each fork prong 106, 108 proximate to each contact point 110, 112, is may generally be triangular, having convex side 606 and two concave sides 608, 610.

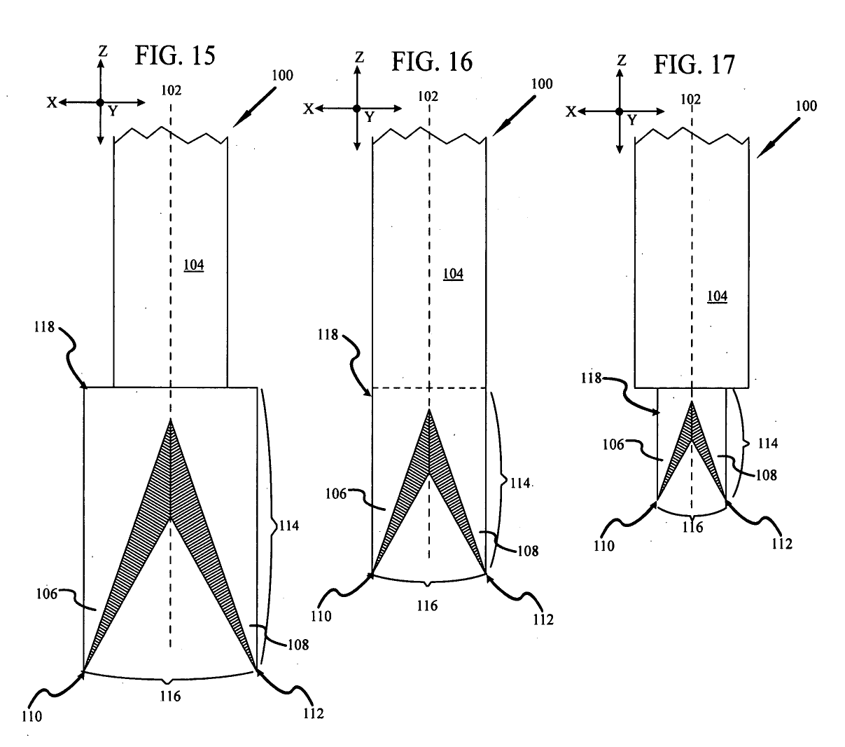

With respect to FIGS. 3 and 6 and the side cutaway views of FIGS. 2, 5 and 8, it is appreciated that contact points 110, 112 are provided at the apex of fork prongs 106, 108 of tip 114 opposite from probe shaft 104, by a tapering structure coupled to the shaft 104. In at least one embodiment tip 114 is an integral component of shaft 104 such that pronged fork probe tip 100 is said to be headless, as shown for example in FIGS. 3, 6 and 16. In at least one alternative embodiment, a clearly identifiable structure (i.e., a head) provides tip 114 such that pronged fork probe tip 100 is said to have a head or be headed, as shown for example in FIGS. 15 and 17. To provide such a larger or smaller head section of tip 114, the shaft 104 may step taper as shown, or gradually taper in or out so as to provide a larger or smaller head section of tip 114. The starting location of the head upon the shaft 104 is illustrated by dotted line 118 in FIGS. 1˜8.

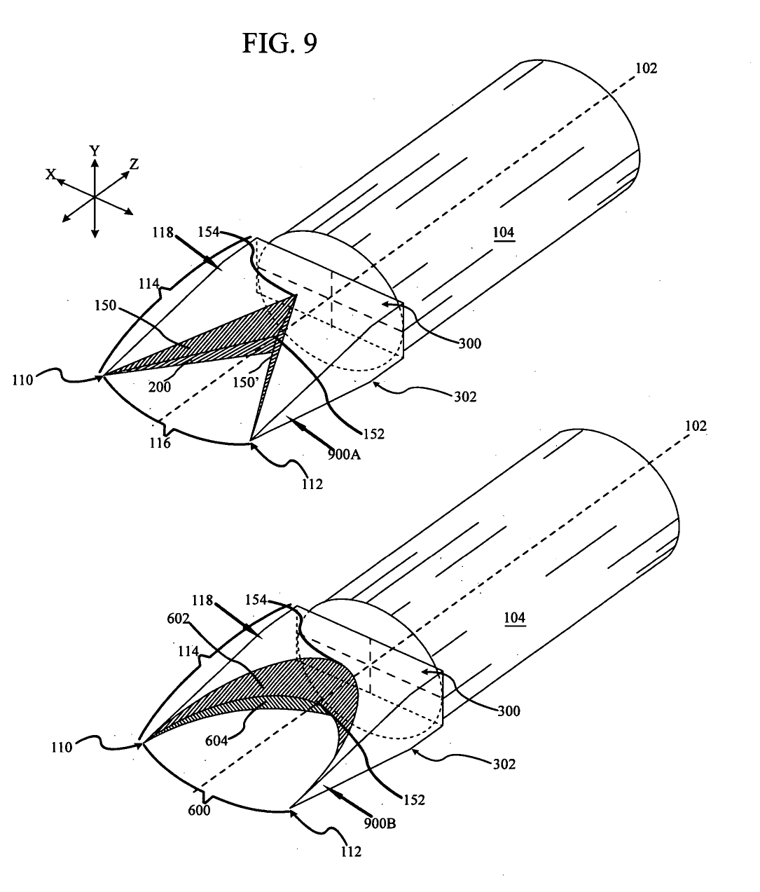

FIG. 9 shows two alternative embodiments for head structures 900 (shown as 900A and 900B) providing fork prongs 106, 108 with respective contact points 110, 112 and self-cleaning spaces 116, 600. As illustrated, each head structure has a width substantially identical to the diameter of shaft 104, and each head is generally rectangular at the point of coupling to the shaft 104. Moreover, in at least one embodiment, the head 900 at the point of union with shaft 104 has substantially the same geometry as shaft 104. In at least one alternative embodiment, the head 900 at the point of union with the shaft 104 has substantially different geometry from shaft 104.

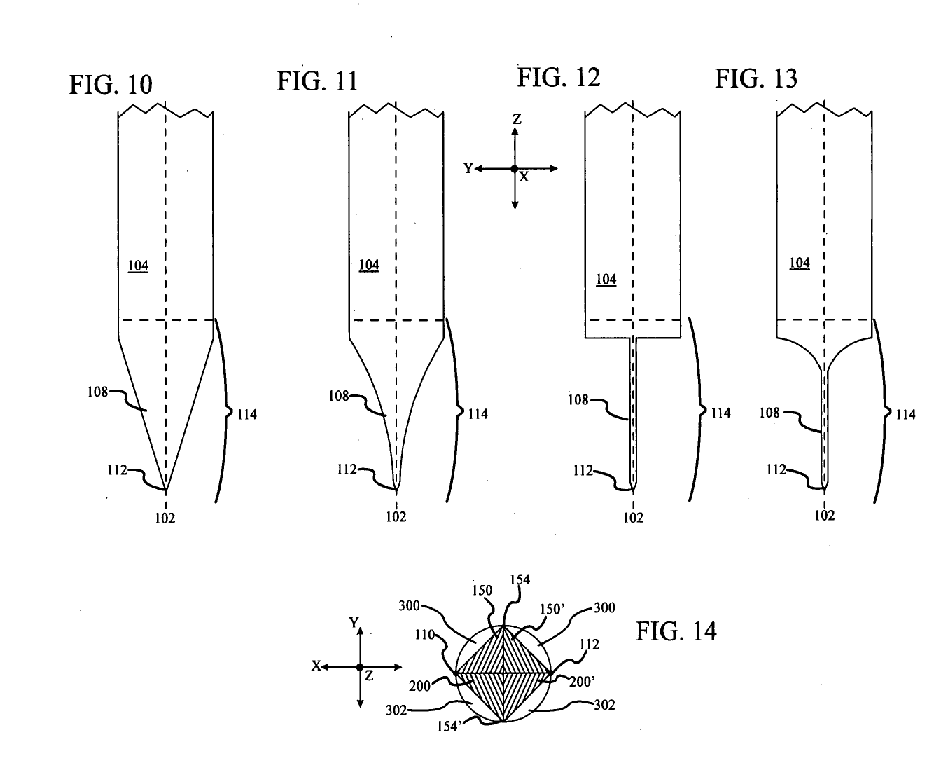

Shown in FIGS. 10˜13 are four side views of alternative embodiments for probe tip 114 of pronged fork probe tip 100. More specifically, the tip 114 may taper at a an angle with straight lines, as shown in FIG. 10. It may also have scalloped sides, as shown in FIG. 11. In yet another alternative embodiment, fork prongs 106, 108 are quite pronounced, as in FIG. 12. Fork prongs 106, 108 may also taper quickly as in FIG. 13.

FIG. 14 is a bottom view of the embodiment generally corresponding to FIGS. 1˜3 and 9. In this view, the singularity nature of contact points 110, 112 may be further appreciated. For ease of identification, each contact point 110, 112 is shown as an exaggerated dot, and not a straight line or bounded geometric area.

As shown in FIGS. 11˜13, there is an additional taper to the end of tip 114, to insure that the proper approach angle is provided to achieve contact points 110, 112. More specifically, it is intended that contact points 110, 112 be sufficiently sharp so as to penetrate the surface of intended circuit nodes so as to establish proper electrical contact for testing purposes. Self-cleaning spaces 116 and 600 help insure that contact points 110, 112 are not impeded from contacting a test node.

The face angle establishing contact points 110, 112 will be application specific and will depend on several factors including, but not limited to, the diameter of the probe shaft 104, the intended applied force during testing, the type of node being tested, the material forming the pronged fork probe tip 100, and the material forming and/or covering the node to be tested (such as, for example, lead free solder). Generally, the face angle will be in a range from about ten degrees (10°) to about thirty five degrees (35°). The distance between the contact points 110, 112 is set so that each contact point 110, 112 hits just inside the pad flange of the test target, thus avoiding the bulk of the central pool of flux residue residing in the through hole. Alternatively, distance between the contact points 110, 112 may be set so that contact point 110, 112 hits the pad flange of the test target, thus also avoiding the central pool of flux residue residing in the through hole. The profile for the fork prongs 106, 108 and the face angle providing contact points 110, 112 may be formed using manufacturing processes that are well understood in the field of art relating to electrical test probes, including but not limited to casting, milling, machining, grinding, sharpening, polishing, stamping and combinations thereof.

So as to permit electrical testing of a node upon a circuit, the shaft is suitable for electrical coupling with test equipment and the probe tip 114 is suitable for electrically coupling to a node on a circuit. More specifically, the shaft 104 is formed from an electrically conductive material such as, but not limited to, brass, nickel, copper, beryllium, steel, stainless steel, aluminum, titanium and combinations thereof. In at least one embodiment, the shaft is formed from steel. In addition, contact points 110, 112, the head 114 and the shaft 104 may be plated with conductive materials such as gold, silver or combinations thereof to further enhance probe life, the electrically conductive properties of the probe and/or prevent oxidation.

As with the shaft, the fork prongs 106, 108 are formed from an electrically conductive material such as, but not limited to, brass, nickel, copper, beryllium, steel, stainless steel, aluminum, titanium and combinations thereof. In at least one embodiment, the fork prongs 106, 108 are formed from the same material providing the shaft 104. In addition, the fork prongs 106, 108 and more specifically the contact points 110, 112, may be plated with a material such as gold, silver or combinations thereof to further enhance probe life, the electrically conductive properties of the probe and/or prevent oxidation.

Much as pronged fork probe tip 100 may incorporate a head 900A or 900B (see FIG. 9) to provide tip 114, which may or may not have substantially the same geometry as shaft 104, the cross sectional width of tip 114 may be larger or smaller than the shaft 104, as illustrated in FIGS. 15˜17. For example, FIG. 15 illustrates a cross sectional width of tip 114 that is larger than the cross sectional width of shaft 104, whereas FIG. 17 shows a tip 114 having a smaller cross sectional width than that of shaft 104. The cross sectional width of the tip 114 may also be substantially the same as that of the probe shaft 104, as in FIG. 16. Moreover, different embodiments may incorporate a distinct head element for tip 114 as shown in FIGS. 15 and 17, or an integrated head element for tip 114 as shown in FIG. 16. Furthermore, the head 900A or 900B and the shaft 104 cross-sections may be either rounded or rectangular independently of each other.

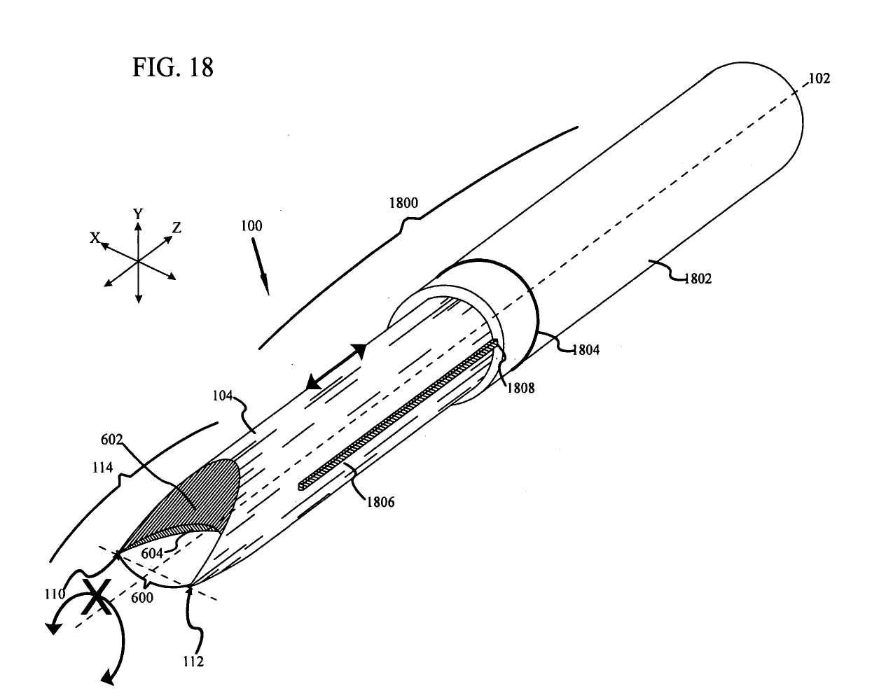

In addition, in at least one embodiment the shaft 104 includes a plunger. Specifically, a portion of shaft 104 opposite from the fork prongs 106, 108 is a plunger 1800 as shown in FIG. 18. The plunger is structured and arranged to fit and be retained within a barrel 1802. The barrel 1802 provides a structure, such as a crimp 1804 that prevents the plunger 1800 from altogether exiting the barrel 1802, while allowing the plunger 1800 to travel or move within a range set by design within the barrel 1802 along the probe axis 102 as shown in FIG. 18.

Internal to the barrel 1802, and thus not shown, is a partially compressed spring abutting the end of the plunger 1800 and the end of the barrel 1802. When compressed to a set depth, typically a portion of the full travel, the spring provides a measured force to the plunger 1800 and thus the shaft 104 when the shaft is brought into contact with a node. In at least one embodiment, the plunger 1800 is allowed to freely rotate within the barrel 1802, so that the probe tip 114 consequently rotates about central axis 102.

In at least one alternative embodiment, the plunger 1800 and barrel 1802 may also be provided with a structure to prevent rotation of the pronged fork probe tip 100. In at least one embodiment, such a rotation prevention structure, such as a tongue and grove arrangement, is internal to the barrel 1802. For illustrative purposes, an embodiment is shown wherein such a structure is a ridge 1806 along shaft 104 (and the plunger 1800 portion of the shaft 104) and grove 1808 in barrel 1802. The choice of a rotation prevention structure is a matter of design preference. In other words, the plunger 1800 permits motion of the pronged fork probe tip 100 along the probe axis 102 while it prevents its rotational motion. Moreover, as shown in FIG. 18, the tip 114 of pronged fork probe tip 100 may translate along the Z axis, but it is restrained from rotating about the Z axis. Such a fixed orientation is advantageous in many embodiments.

In at least one embodiment, the barrel of the pronged fork probe tip 100 is structured and arranged to be received by a conductive receptacle or socket (not shown) which by features such as detents or mere friction holds onto the barrel 1802 of the pronged fork probe tip 100. In at least one embodiment, the receptacle or socket does not allow the barrel 1802 to rotate after the barrel has been inserted into the receptacle or socket. The receptacle or socket is typically made part of test fixtures and is typically embedded in a non-conductive material and arranged in a matrix that matches the location of the nodes to be probed. Furthermore, this receptacle or socket is typically used to make connections within a test system from the test fixture and in effect connects the node through the probe to the electronics test equipment of the test system.

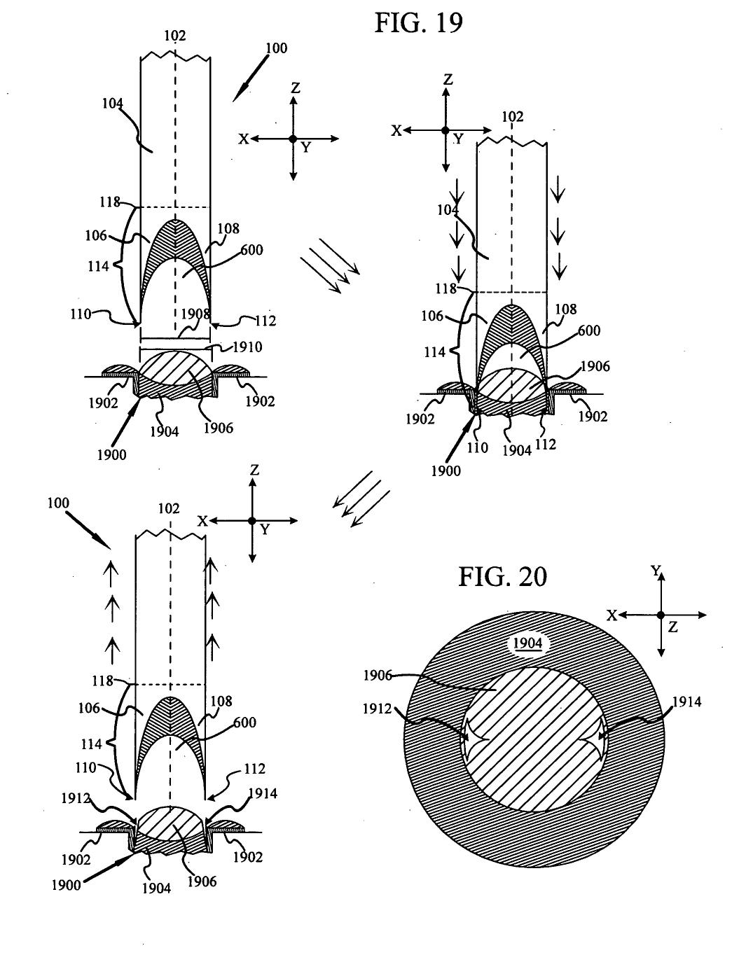

As stated above, the pronged fork probe barrel 1802 is typically force fitted into a receptacle. Such a force fit may be used to provide a fixed preferred orientation for the pronged fork probe tip 100 when it incorporates a structure to prevent rotation, that is, to provide a non-rotating probe or fixed orientation probe. During the testing process, it is not uncommon for a node to be slightly misaligned. When a testing probe is free to rotate about its axis, such misalignment may result in the probe rotating to a position that the fork prongs 106, 108 miss the contact surface of the node 1902 as shown in FIG. 19. Such misalignment may reduce the quality or prevent altogether repeatable electrical contact and result in false readings and node failures.

Instead of resorting to test fixture repairs which can be expensive, time-consuming and result in production line down time, a non-rotating pronged fork probe tip 100 that is best suited to the node width, taking the misalignment into account, may be used to insure that the fork prongs 106, 108 do not miss the intended contact surface 1902 or 1906, depending on the targeted surface of the node 1900. In other words, a non-rotating pronged fork probe tip 100 may be physically set in the test fixture to be aligned to effectively strike the misaligned node. As the pronged fork probe tip 100 does not rotate, such set alignment will be maintained. A fixed orientation probe may also be used to avoid undesired contact with conductive traces too near a node or to prevent damage to or contact with components nearby.

It is appreciated that there are a variety of different nodes on a circuit that may require testing. A particular type of node is known as a through hole. Holes and/or through holes are frequently used to mount components and/or provide board interconnections when reflowed solder is flowed into the hole to partially or completely fill the hole. During the reflow process, flux material will pool to the surface and solidify on top of the solder. This flux material may lie below the top of the hole, be flush with the top of the solder on the node or flood over it. Pronged fork probe tip 100 advantageously overcomes the problems of testing hole nodes or through-hole nodes encountered by other test probes by avoiding the bulk of the pooled flux or the thickest portions thereof.

Having described the physical structure of the two pronged fork probe tip 100, additional advantages of the structure may well be appreciated through the discussion of an embodiment for at least one method of use. This description is provided with reference to FIG. 19. It will be appreciated that the described method need not be performed in the order in which it is herein described, but that this description is merely exemplary of one method of using the pronged fork probe tip 100.

As shown in the top left of FIG. 19, a pronged fork probe tip 100 as described above is provided above a node hole 1900 for testing. The illustrations in FIG. 19 depict a cross section of node hole 1900 showing the pad 1902 and solder 1904 upon the pad and within the node hole 1900. Flux 1906 has pooled on top of the solder 1904 within the node hole 1900 upon the solder concave meniscus.

For a straight flat blade probe, a spear probe or a probe providing a single point of contact at the center of the node, the flux 1906 as shown poses a significant impediment to testing the node hole 1900. Flat bladed probes exhaust their force over large contact surface areas, thereby making it more difficult to penetrate the residue flux 1906. Higher spring forces may also be used with flat bladed probes or spear probes in an effort to insure penetration through the flux or residue material. However, such higher spring forces may increase the chance of damage to the board.

In the particular application shown, it is appreciated that the pronged fork probe tip 100 is sized with a dimension 1908 between the contact points 110, 112 that is less than the internal diameter 1910 of node hole 1900. As such, it is appreciated that the pronged fork probe tip 100 is intended to establish contact at the shallow ends of solder 1904 meniscus within node hole 1900, and not the adjoining pad 1902 surrounding the node hole 1900 or the center of the node hole 1900 where the flux 1906 accumulation is thickest.

As the pronged fork probe tip 100 is urged into contact with the node hole 1900, contact points 110, 112 each contact an edge portion of the solder 1904 within node hole 1900. Pronged fork probe tip 100 advantageously avoids attempts to reach solder 1904 within the hole through flux 1906. Should flux or other debris cover the node hole 1900, self-cleaning space 600 permits contact points 110, 112 to contact the solder 1904 without succumbing to obstruction or residue accumulation on the probe tip 114.

Moreover, the depth of solder 1904 along the edge portion of the hole 1900 is typically minimal, with respect to the depth at the center of the hole 1900, where it is greatest, due to the solder 1904 surface tension being lower than the capillary action formed between the solder 1904 and the walls of the hole, in turn forming a concave meniscus on the surface of the solder 1904. Thus the collection of debris, such as flux 1906, is also typically much thicker proximate to the general center of the node hole 1900. Moreover, as shown, the mound of flux 1906 and or other debris may extend at least part way into self-cleaning space 600, yet as shown, each fork prong 106, 108 has passed through a substantially thinner area of flux 1906, and made significant penetration into solder 1904.

As each fork prong 106, 108 makes initial contact at a single point, the applied force from the shaft 104 to the node hole 1900 is only halved. More specifically, if a pressure force of twelve units (units are arbitrary) is applied to a single point, the full twelve units of force are realized at that point. Assuming the same contact surface area per contact point, as the number of contact points increases (i.e., the area of contact increases) the contact force and pressure realized at each point of contact decreases. With two points of contact, an applied twelve units of force is realized by each contact point as six units of force. With three points of contact, an applied twelve units of pressure force is realized by each contact point as only four units of force.

Moreover, since the forked probe tip 100 only makes contact with the node hole 1900 at two points, the applied force from the shaft 104 to the node hole 1900 is only halved. More specifically, if a force of twelve units (units are arbitrary) is applied to a single point, the full twelve units of force are realized at that point. As the number of contact points increases (i.e., the area of contact increases) the contact force realized at each point of contact decreases. With two points of contact, an applied twelve units of force results in six units of force at each contact point. With three points of contact, an applied twelve units of force is realized by each contact point as only four units of force.

Using probes of greater force to overcome flux residue, may risk damaging the board, the soldered nodes or the components, particularly when used in great numbers for probing high density boards. The greater pressure realized from lower probe forces attained by contact points 110, 112 of fork prongs 106, 108 increases the probability that contact points 110, 112 will electrically make contact with the solder surface within node hole 1900 without destructive damage to the board, solder or node hole 1900.

As pronged fork probe tip 100 is extracted from the node hole 1900, the extraction reveals two solder indentations 1912, 1914 (also known as witness marks) within the node hole 1900. Punctures 1912, 1914 are advantageously unique to pronged fork probe tip 100. As shown and described above with respect to FIGS. 3 and 6, the cross section of each fork prong 106, 108 is generally triangular. In at least one embodiment, each puncture has a convex edge and two straight edges. In at least one alternative embodiment, each puncture has a convex edge and two concave edges, as illustrated in FIG. 20, showing a top view of node hole 1900 after removal of pronged fork probe tip 100. These embodiments are not all inclusive since, in an alternative embodiment (not shown), the solder indentations 1912 may be in the shape of a diamond, rhomb, cone or other shape. Upon visual inspection of a tested hole node 1900, an observer may easily determine whether a pronged fork probe tip 100 was used in the testing process or determine the alignment accuracy of the probe on the fixture to the node.

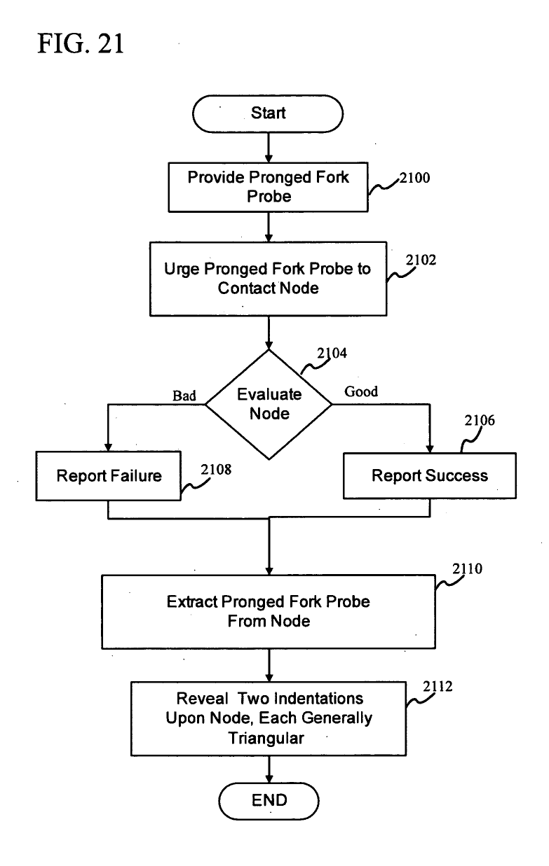

This method is summarized in the flowchart of FIG. 21. The method commences by providing a pronged fork probe tip 100 such as described above with respect to FIGS. 1˜18, block 2100. The pronged fork probe tip 100 is urged to contact the node, block 2102. More specifically, contact points 110, 112 provided by fork prongs 106, 108 respectively, dispose into the edge of the solder surface within the node hole (see FIG. 19).

Upon establishing contact between the pronged fork probe tip 100 and node, the node is electrically evaluated, decision 2104. If the node evaluates as good, it may be reported or recorded, block 2106, and if the node evaluates as bad, it is reported as bad, block 2108. In at least one embodiment, circuits with bad nodes are discarded so as to save further processing costs.

Following evaluation, the pronged fork probe tip 100 is extracted from the node, block 2110. As indicated above the extraction process leaves behind two curved indentations or witness marks upon the node, block 2112, which may be used to confirm use of pronged fork probe tip 100 or inspect its alignment to node in the testing process.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A pronged fork probe tip for probing a node on a circuit, comprising:
a longitudinal probe axis;
a shaft made from an electrically conductive material, the shaft concentric to the probe axis;
two fork prongs coupled to the shaft and parallel to the probe axis, each fork prong providing an end contact point; and
a self-cleaning space disposed between the two fork prongs.

2. The pronged fork probe tip of claim 1, wherein the self-cleaning space has a central area disposed between the two fork prongs along a first axis, the self-cleaning space having an exit area above the central area along a second axis crossing the first axis.

3. The pronged fork probe tip of claim 1, wherein the self-cleaning space is provided by two intersecting portions of at least two curved surfaces.

4. The pronged fork probe tip of claim 1, wherein the end contact points lie in a plane transverse to the probe axis.

5. The pronged fork probe tip of claim 1, wherein each fork prong has a generally triangular cross section consisting of a convex side and two straight sides.

6. The pronged fork probe tip of claim 1, wherein each fork prong has a generally triangular cross section consisting of a convex side and two concave sides.

7. The pronged fork probe tip of claim 1, wherein the shaft includes a plunger permitting movement of the shaft and the fork prongs along the probe axis

8. The pronged fork probe tip of claim 1, wherein the shaft includes a plunger permitting movement of the shaft and the fork prongs along the probe axis in a fixed orientation.

9. The pronged fork probe tip of claim 1, wherein the probe tip is operable to make contact between each contact point and an edge solder surface within a through hole node, the contact points concentrating an applied force from the shaft to the node.

10. The pronged fork probe tip of claim 1, further including a head joined to the shaft, the two fork prongs joined to the head opposite from the shaft, the self-cleaning space disposed at least partially within the head.

11. The pronged fork probe tip of claim 1, wherein the two fork prongs are defined by two opposing faces about the probe axis, the faces converging towards each other along a first axis along the probe axis, the faces separating and tapering to points along a second axis transverse to the probe axis.

12. A pronged fork probe tip for probing a node on a circuit, comprising:
a longitudinal probe axis;
a shaft made from an electrically conductive material, the shaft concentric to the probe axis, the shaft having two faces symmetrically about the probe axis facing and in opposition to each other, the faces converging towards each other along the probe axis; and
a self-cleaning space disposed through the converging faces, the self-cleaning space dividing the converging faces into two fork prongs, each providing an end contact point.

13. The two pronged fork probe tip of claim 12, wherein the self-cleaning space has a central area disposed between the two fork prongs along a first axis, the self-cleaning space having an exit area above the central area along a second axis crossing the first axis.

14. The pronged fork probe tip of claim 12, wherein the self-cleaning space is provided by two intersecting portions of at least two curved surfaces.

15. The pronged fork probe tip of claim 12, wherein the end contact points lie in a plane transverse to the probe axis.

16. The pronged fork probe tip of claim 12, wherein the probe tip is operable to make contact between each contact point and an edge solder surface of a solder well within a hole node, the contact points concentrating an applied force from the shaft to the node.

17. The pronged fork probe tip of claim 12, wherein the shaft includes a plunger permitting movement of the shaft and the fork prongs along the probe axis

18. The pronged fork probe tip of claim 12, wherein the shaft includes a plunger permitting movement of the shaft and the fork prongs along the probe axis in a fixed orientation.

19. A two pronged fork probe tip for probing a node on a circuit, comprising:
a longitudinal probe axis;
a shaft made from an electrically conductive material, the shaft concentric to the probe axis;
a head joined to the shaft along the probe axis, the head having two faces symmetrically about the probe axis facing and in opposition to each other, the faces converging towards each other along the probe axis;
a self-cleaning space disposed through the converging faces, the self-cleaning space dividing the converging faces into two fork prongs, each providing an end contact point; and
wherein the probe tip is operable to make contact between each contact point and an edge solder surface of a solder well within a through hole node, the contact points concentrating an applied force from the shaft to the node.

20. The two pronged fork probe tip of claim 19, wherein the head has a width and the shaft has a width, the head width equal to the shaft width.

21. The two pronged fork probe tip of claim 19, wherein the head has a width and the shaft has a width, the head width less than or greater than the shaft width.

22. The two pronged fork probe tip of claim 19, wherein the head, the shaft or both have an elliptical cross-section.

23. The two pronged fork probe tip of claim 19, wherein the head, the shaft or both have a non-elliptical cross-section.

24. The two pronged fork probe tip of claim 19, wherein each fork prong has a generally triangular cross section consisting of a convex side and two straight sides.

25. The two pronged fork probe tip of claim 19, wherein each fork prong has a generally triangular cross section consisting of a convex side and two concave sides.

26. The two pronged fork probe tip of claim 19, wherein the self-cleaning space has a central area disposed between the two fork prongs along a first axis, the self-cleaning space having an exit area above the central area along a second axis crossing the first axis.

27. The two pronged fork probe tip of claim 19, wherein the self-cleaning space is provided by two intersecting portions of at least two curved structures.

28. The pronged fork probe tip of claim 19, wherein the shaft includes a plunger permitting movement of the shaft and the fork prongs along the probe axis

29. The pronged fork probe tip of claim 19, wherein the shaft includes a plunger permitting movement of the shaft and the fork prongs along the probe axis in a fixed orientation.

30. A method of using a pronged fork probe tip for probing a through hole node on a circuit, comprising:
providing a probe having;
a longitudinal probe axis;
a shaft made from an electrically conductive material, the shaft concentric to the probe axis;
two fork prongs coupled to the shaft and parallel to the probe axis, each fork prong providing an end contact point;
a self-cleaning space disposed between the two fork prongs;
urging the probe to contact an edge of a solder well surface within the through hole, each contact point disposing into the solder;
electrically evaluating the node; and
extracting the probe from the node, the extraction revealing two indentations within the edge of the solder well within the through hole.

31. The method of claim 30, wherein the method concentrates an applied force from the shaft through the two contact points to areas of the solder well having minimal flux material.

32. The method of claim 30, wherein each fork prong has a generally triangular cross section consisting of a convex side and two straight sides, the revealed indentations having a geometry consistent with the fork prongs.

33. The method of claim 30, wherein each fork prong has a generally triangular cross section consisting of a convex side and two concave sides, the revealed indentations having a geometry consistent with the fork prongs.
